(19) United States
(12) Patent Application Publication
(10) Pub. No.: US 2010/0158133 A1
(43) Pub. Date: Jun. 24, 2010

(54) Method and Apparatus for Using High-Level Syntax in Scalable Video Encoding and Decoding

(76) Inventors: Peng Yin, West Windsor, NJ (US); Jill MacDonald Boyce, Manalapan, NJ (US); Purvin Bibhas Pandit, Franklin Park, NJ (US)

Correspondence Address: Robert D. Shedd, Patent Operations;THOMSON Licensing LLC, P.O. Box 5312, Princeton, NJ, 08543-5312, US

(21) Appl. No.: 11/992,621

(22) PCT Filed: Aug. 29, 2006
(86) PCT No.: PCT/US06/33767

§ 371 Date: Mar. 26, 2008

Related U.S. Application Data
(60) Provisional application No. 60/725,837, filed on Oct. 12, 2005.

(51) Int. Cl. H04N 7/26

(52) U.S. Cl. 375/240.26; 375/240.01; 375/E07.078

(57) ABSTRACT

According to an aspect of the present invention, there are provided method and apparatus for using high-level syntax in scalable video encoding and decoding. In one embodiment, a scalable video encoder includes an encoder for encoding video signal data by adding fragment order information in a network abstraction layer unit header (440). In another embodiment, a scalable video encoder includes an encoder for encoding video signal data by adding (430) fragment order information in a scalable supplementary enhancement information message corresponding to the video signal data.

### CROSS-REFERENCE TO RELATED APPLICATIONS

This application claims the benefit of U.S. Provisional Application Ser. No. 60/725,837, filed Oct. 12, 2005 and entitled “METHOD AND APPARATUS FOR HIGH LEVEL SYNTAX IN SCALABLE VIDEO ENCODING AND DECODING,” which is incorporated by reference herein in its entirety.

### FIELD OF THE INVENTION

The present invention relates generally to video encoding and decoding and, more particularly, to a method and apparatus for scalable video encoding and decoding using high-level syntax.

### BACKGROUND OF THE INVENTION

The concept of fine grain scalability (FGS) fragment network abstraction layer (NAL) units was adopted in Joint Scalable Video Model Version 3.0 (hereinafter “JSVM3”) for scalable video coding. fragment_order information together with quality_level information (concatenated as [quality_level, fragment_order]) is used to support medium and fine grain signal-to-noise ratio (SNR) scalability, as shown in FIG. 1. Turning to FIG. 1, network abstraction layer (NAL) units for combined scalability are indicated generally by the reference numeral 100. Temporal scalability is indicated along the x-axis, spatial scalability is indicated along the y-axis, and SNR scalability is indicated along the Z-axis.

Currently, the quality level is indicated in a NAL unit header or a sequence parameter set (SPS), while fragment_order is indicated in slice header. That is, quality_level is indicated in a NAL unit header if NAL unit extension_flag is equal to 1 or in a SPS if nal_unit_extension_flag is equal to 0, while fragment_order is indicated in a slice header. This makes processing fragment_order challenging for a router or gateway.

In a first prior art implementation relating to JSVM3, the NAL unit header has an option to support a one-byte solution or a two-byte solution for parsing as shown in Table 1 and Table 2, respectively. The one-byte solution can be used to: (a) support fixed path bitstream extraction by dropping packets that are smaller than or equal to a given target value; and (b) support an adaptation path, but at the cost of parsing a SPS to establish a 1-D (simple_priority_id) to 3-D (spatial, temporal, SNR) relationship. Routers that support a simpler one-dimensional decision can simply use the one-byte NAL unit header solution. The two-byte solution involves using explicit 3-D scalability information to determine the adaptation path but at the cost of one byte overhead per NAL unit. Routers that can support a more sophisticated three-dimensional decision can use the two-byte NAL unit header solution. For the two-byte solution, simple_priority_id is not used by the decoding process specified in JSVM3.

TABLE 1

| | | | | | | | |
|---|---|---|---|---|---|---|---|
| 0 | 1 | 2 | 3 | 4 | 5 | 6 | 7 |

| | | |
|---|---|---|
| simple_priority_id | discardable_flag | 0 |

TABLE 2

| | | | | | | | | | | | | | | | |
|---|---|---|---|---|---|---|---|---|---|---|---|---|---|---|---|
| 0 | 1 | 2 | 3 | 4 | 5 | 6 | 7 | 8 | 9 | 10 | 11 | 12 | 13 | 14 | 15 |

| | | | | | |
|---|---|---|---|---|---|
| simple_priority_id | discardable_flag | 1 | temporal_level | dependency_id | quality_level |

In the first prior art implementation, fragment_order is indicated in a slice header, as shown in Table 3.

TABLE 3

| slice_header_in_scalable_extension( ) { | C | Descriptor |
|---|---|---|
| first_mb_in_slice | 2 | ue (v) |
| slice_type | 2 | ue (v) |
| if( slice_type == PR ) { | | |
| fragmented_flag | 2 | u (1) |
| if ( fragmented_flag == 1 ) { | | |
| fragment_order | 2 | ue (v) |
| if ( fragment_order != 0) | | |
| last_fragment_flag | 2 | u (1) |
| } | | |
| if ( fragment_order == 0 ) { | | |
| num_mbs_in_slice_minus1 | 2 | ue (v) |
| luma_chroma_sep_flag | 2 | u (1) |
| } | | |
| } | | |
| ... | | |
| } | | |

In a second prior art implementation with respect to JSVM3, fragment_order information is added to support a two-byte solution, by using all 6 bits of simple_priority_id for fragment information. The second prior art solution includes at least the following two disadvantages: (a) six bits are needed for the second prior art implementation versus only 2 bits for the first prior art implementation; and (b) the second prior art implementation does not leaves an additional option for a current application.

### SUMMARY OF THE INVENTION

These and other drawbacks and disadvantages of the prior art are addressed by the present invention, which is directed to a method and apparatus for scalable video encoding and decoding using high-level syntax.

According to an aspect of the present invention, there is provided a scalable video encoder. The scalable video encoder includes an encoder for encoding video signal data by adding fragment order information in a network abstraction layer unit header.

According to another aspect of the present invention, there is provided a scalable video encoder. The scalable video encoder includes an encoder for encoding video signal data by adding fragment order information in a scalable supplementary enhancement information message.

According to yet another aspect of the present invention, there is provided a method for scalable video encoding. The method includes encoding video signal data by adding fragment order information in a network abstraction layer unit header.

According to a further aspect of the present invention, there is provided a method for scalable video encoding. The method includes encoding video signal data by adding fragment order information in a scalable supplementary enhancement information message corresponding to the video signal data.

According to a yet further aspect of the present invention, there is provided a scalable video decoder. The scalable video decoder includes a decoder for decoding video signal data by reading fragment order information in a network abstraction layer unit header corresponding to the video signal data.

According to an additional aspect of the present invention, there is provided a scalable video decoder. The scalable video decoder includes a decoder for decoding video signal data by reading fragment order information in a scalable supplementary enhancement information message corresponding to the video signal data.

According to a further additional aspect of the present invention, there is provided a method for scalable video decoding. The method includes decoding video signal data by reading fragment order information in a network abstraction layer unit header corresponding to the video signal data.

According to another aspect of the present invention, there is provided a method for scalable video decoding. The method includes decoding video signal data by reading fragment order information in a scalable supplementary enhancement information message corresponding to the video signal data.

These and other aspects, features and advantages of the present invention will become apparent from the following detailed description of exemplary embodiments, which is to be read in connection with the accompanying drawings.

### BRIEF DESCRIPTION OF THE DRAWINGS

The present invention may be better understood in accordance with the following exemplary figures, in which:

FIG. 1 is a block diagram illustrating network abstraction layer (NAL) units for combined scalability to which the present invention may be applied;

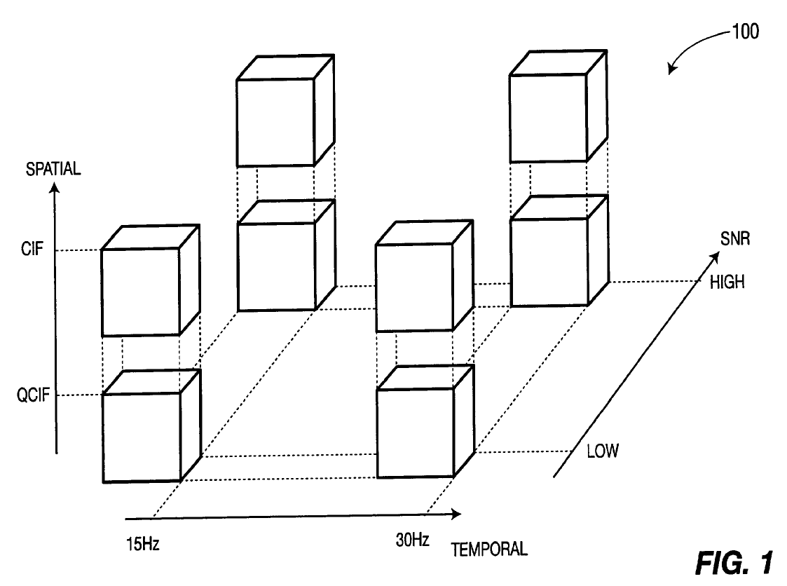

FIG. 2 shows a block diagram for an exemplary Joint Scalable Video Model (JSVM) 3.0 encoder to which the present principles may be applied, in accordance with an embodiment of the present principles;

FIG. 3 shows a block diagram for an exemplary decoder to which the present principles may be applied, in accordance with an embodiment of the present principles;

FIG. 4 shows a flow diagram for an exemplary method for scalable video encoding using high-level syntax in accordance with an embodiment of the present principles; and

FIG. 5 shows a flow diagram for an exemplary method for scalable video decoding using high-level syntax in accordance with an embodiment of the present principles.

### DETAILED DESCRIPTION

The present invention is directed to a method and apparatus for scalable video encoding and decoding using high-level syntax.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

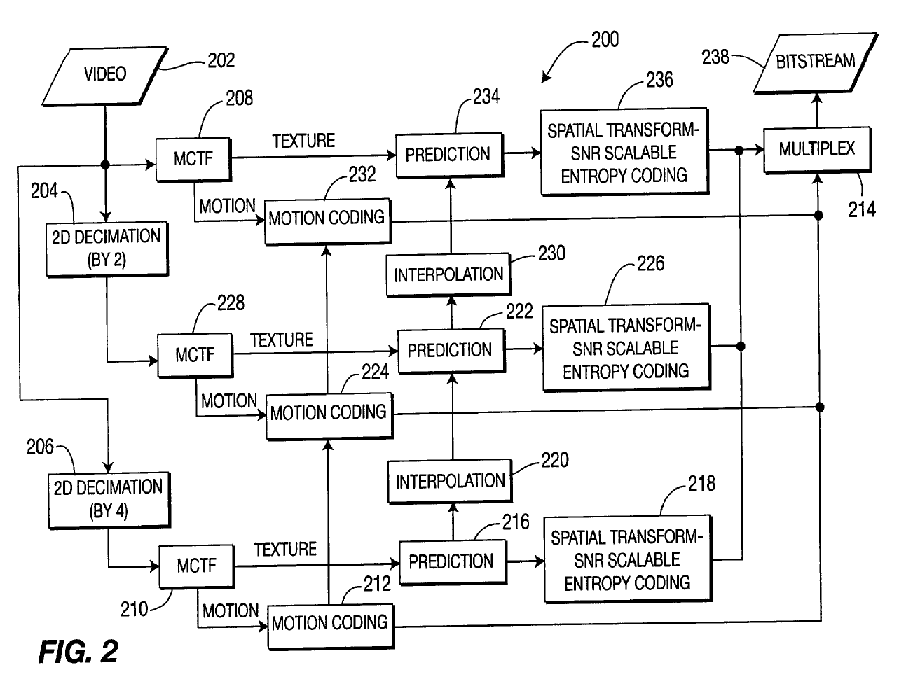

Turning to FIG. 2, an exemplary Joint Scalable Video Model Version 2.0 (hereinafter “JSVM3.0”) encoder to which the present invention may be applied is indicated generally by the reference numeral 200. The JSVM3.0 encoder 200 uses three spatial layers and motion compensated temporal filtering. The JSVM encoder 200 includes a two-dimensional (2D) decimator 204, a 2D decimator 206, and a motion compensated temporal filtering (MCTF) module 208, each having an input for receiving video signal data 202.

An output of the 2D decimator 206 is connected in signal communication with an input of a MCTF module 210. A first output of the MCTF module 210 is connected in signal communication with an input of a motion coder 212, and a second output of the MCTF module 210 is connected in signal communication with an input of a prediction module 216. A first output of the motion coder 212 is connected in signal communication with a first input of a multiplexer 214. A second output of the motion coder 212 is connected in signal communication with a first input of a motion coder 224. A first output of the prediction module 216 is connected in signal communication with an input of a spatial transformer 218. An output of the spatial transformer 218 is connected in signal communication with a second input of the multiplexer 214. A second output of the prediction module 216 is connected in signal communication with an input of an interpolator 220. An output of the interpolator is connected in signal communication with a first input of a prediction module 222. A first output of the prediction module 222 is connected in signal communication with an input of a spatial transformer 226. An output of the spatial transformer 226 is connected in signal communication with the second input of the multiplexer 214. A second output of the prediction module 222 is connected in signal communication with an input of an interpolator 230. An output of the interpolator 230 is connected in signal communication with a first input of a prediction module 234. An output of the prediction module 234 is connected in signal communication with a spatial transformer 236. An output of the spatial transformer is connected in signal communication with the second input of a multiplexer 214.

An output of the 2D decimator 204 is connected in signal communication with an input of a MCTF module 228. A first output of the MCTF module 228 is connected in signal communication with a second input of the motion coder 224. A first output of the motion coder 224 is connected in signal communication with the first input of the multiplexer 214. A second output of the motion coder 224 is connected in signal communication with a first input of a motion coder 232. A second output of the MCTF module 228 is connected in signal communication with a second input of the prediction module 222.

A first output of the MCTF module 208 is connected in signal communication with a second input of the motion coder 232. An output of the motion coder 232 is connected in signal communication with the first input of the multiplexer 214. A second output of the MCTF module 208 is connected in signal communication with a second input of the prediction module 234. An output of the multiplexer 214 provides an output bitstream 238.

For each spatial layer, a motion compensated temporal decomposition is performed. This decomposition provides temporal scalability. Motion information from lower spatial layers can be used for prediction of motion on the higher layers. For texture encoding, spatial prediction between successive spatial layers can be applied to remove redundancy. The residual signal resulting from intra prediction or motion compensated inter prediction is transform coded. A quality base layer residual provides minimum reconstruction quality at each spatial layer. This quality base layer can be encoded into an H.264 standard compliant stream if no inter-layer prediction is applied. For quality scalability, quality enhancement layers are additionally encoded. These enhancement layers can be chosen to either provide coarse or fine grain quality (SNR) scalability.

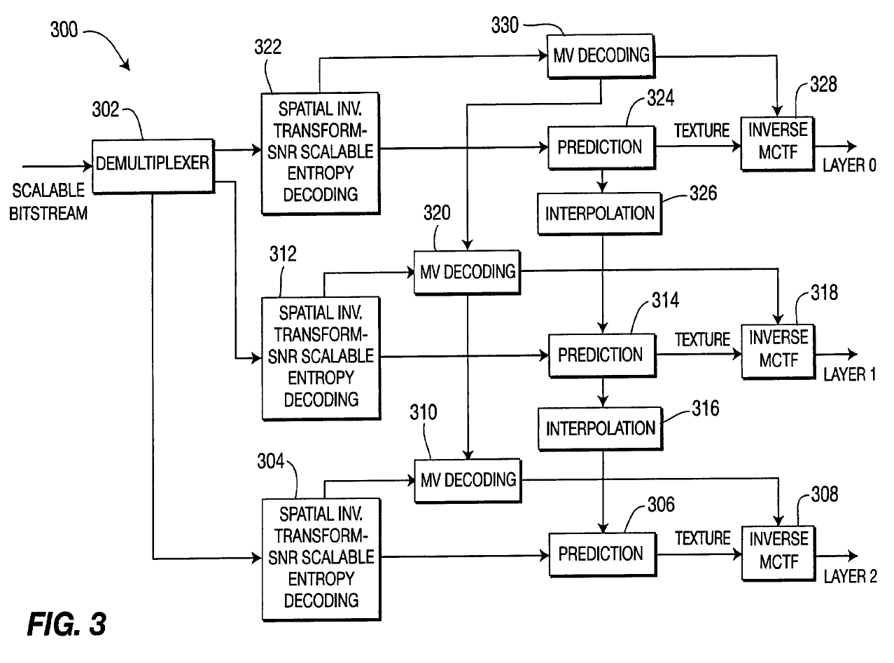

Turning to FIG. 3, an exemplary scalable video decoder to which the present invention may be applied is indicated generally by the reference numeral 300. An input of a demultiplexer 302 is available as an input to the scalable video decoder 300, for receiving a scalable bitstream. A first output of the demultiplexer 302 is connected in signal communication with an input of a spatial inverse transform SNR scalable entropy decoder 304. A first output of the spatial inverse transform SNR scalable entropy decoder 304 is connected in signal communication with a first input of a prediction module 306. An output of the prediction module 306 is connected in signal communication with a first input of an inverse MCTF module 308.

A second output of the spatial inverse transform SNR scalable entropy decoder 304 is connected in signal communication with a first input of a motion vector (MV) decoder 310. An output of the MV decoder 310 is connected in signal communication with a second input of the inverse MCTF module 308.

A second output of the demultiplexer 302 is connected in signal communication with an input of a spatial inverse transform SNR scalable entropy decoder 312. A first output of the spatial inverse transform SNR scalable entropy decoder 312 is connected in signal communication with a first input of a prediction module 314. A first output of the prediction module 314 is connected in signal communication with an input of an interpolation module 316. An output of the interpolation module 316 is connected in signal communication with a second input of the prediction module 306. A second output of the prediction module 314 is connected in signal communication with a first input of an inverse MCTF module 318.

A second output of the spatial inverse transform SNR scalable entropy decoder 312 is connected in signal communication with a first input of an MV decoder 320. A first output of the MV decoder 320 is connected in signal communication with a second input of the MV decoder 310. A second output of the MV decoder 320 is connected in signal communication with a second input of the inverse MCTF module 318.

A third output of the demultiplexer 302 is connected in signal communication with an input of a spatial inverse transform SNR scalable entropy decoder 322. A first output of the spatial inverse transform SNR scalable entropy decoder 322 is connected in signal communication with an input of a prediction module 324. A first output of the prediction module 324 is connected in signal communication with an input of an interpolation module 326. An output of the interpolation module 326 is connected in signal communication with a second input of the prediction module 314.

A second output of the prediction module 324 is connected in signal communication with a first input of an inverse MCTF module 328. A second output of the spatial inverse transform SNR scalable entropy decoder 322 is connected in signal communication with an input of an MV decoder 330. A first output of the MV decoder 330 is connected in signal communication with a second input of the MV decoder 320. A second output of the MV decoder 330 is connected in signal communication with a second input of the inverse MCTF module 328.

An output of the inverse MCTF module 328 is available as an output of the decoder 300, for outputting a layer 0 signal. An output of the inverse MCTF module 318 is available as an output of the decoder 300, for outputting a layer 1 signal. An output of the inverse MCTF module 308 is available as an output of the decoder 300, for outputting a layer 2 signal.

In order to provide consistency and to allow parsing of fine grain scalability (FGS) fragment information at a network abstraction layer (NAL) unit header or a sequence parameter set (SPS), it is herein proposed to add fragment_order information in a NAL unit header or a SPS, without changing the existing number of bytes in the NAL unit header (e.g., either 1 or 2) or the SPS. Embodiments of the present principles may be used in one-byte and two-byte modes.

In an embodiment of the present principles directed to supporting a one-byte solution that, in turn, supports an adaptation path, we add fragment_order in a SPS, as shown in TABLE 4. That is, Table 4 illustrates the addition of the fragment_order information for a one-byte solution in accordance with the present principles to support an adaptation path by placing fragment_order in a SPS. The cost of placing the fragment_order in the SPS is parsing the SPS to establish a 1D to 3D relationship. fragment_order_list[priority_id] specifies the inferring process for the syntax elements fragment_order.

TABLE 4

| Seq_parameter_set_rbsp( ) { | C | Descriptor |
|---|---|---|
| profile_idc | 0 | u (8) |
| constraint_set0_flag | 0 | u (1) |
| constraint_set1_flag | 0 | u (1) |
| constraint_set2_flag | 0 | u (1) |
| constraint_set3_flag | 0 | u (1) |
| reserved_zero_4bits /* equal to 0 */ | 0 | u (4) |
| level_idc | 0 | u (8) |
| seq_parameter_set_id | 0 | ue (v) |
| if( profile_idc == 83 ) { | | |
| nal_unit_extension_flag | 0 | u (1) |
| if( nal_unit_extension_flag == 0 ) { | | |
| number_of_simple_priority_id_values_minus1 | 0 | ue (v) |
| for( i = 0; i <= number_of_simple_priority_id_values_minus1; i++ ) { | | |
| priority_id | 0 | u (6) |
| temporal_level_list[ priority_id ] | 0 | u (3) |
| dependency_id_list[ priority_id ] | 0 | u (3) |
| quality_level_list[ priority_id ] | 0 | u (2) |
| fragment_order_list[ priority_id ] | 0 | u (2) |
| } | | |
| } | | |
| } | | |
| .................... | | |
| } | | |

The two-byte solution is aimed at 3-D routers, which can make 3-dimensional packet dropping decisions based on spatial, temporal, and quality dimensions. However, when a bitstream is generated, it is not necessarily known in advance whether the bitstream will be processed using 1-D routers or 3-D routers. In the current JSVM3 design, for the two-byte solution, the 6 bits for simple_priority_id are not used by the decoding process.

In an embodiment of the present principles directed to supporting a two-byte solution, we add fragment_order information using two of the low order bits in the space allocated for the simple_priority_id, as shown in Table 5. The remaining four bits are used as a short_priority_id and may be used as determined by the application to indicate 1-D priority.

TABLE 5

| nal_unit( NumBytesInNALunit ) { | C | Descriptor |
|---|---|---|
| forbidden_zero_bit | All | f (1) |
| nal_ref_idc | All | u (2) |
| nal_unit_type | All | u (5) |
| nalUnitHeaderBytes = 1 | | |
| if( nal_unit_type == 20 \|\| nal_unit_type == 21 ) { | | |
| extension_flag | All | u (1) |
| discardable_flag | All | u (1) |
| if (extension_flag == 0 ) | | |
| simple_priority_id | All | u (6) |
| else { | | |
| short_priority_id | All | u (4) |
| fragment_order | All | u (2) |
| temporal_level | All | u (3) |
| dependency_id | All | u (3) |
| quality_level | All | u (2) |
| nalUnitHeaderBytes++ | | |
| } | | |
| nalUnitHeaderBytes++ | | |
| } | | |
| ... | | |
| } | | |

The teachings of the present principles differ from the second prior art implementation in that the second prior art implementation uses all 6 bits of simple_priority_id for fragment information. In accordance with an embodiment of the present principles, we only use the low order two bits, which are enough in the current JSVM design, as specified in the slice header. The quality_level and the frame_order values are concatenated together for the 3rd dimension which indicates SNR scalability for use by the 3-D router. The use of only two bits for the fragment order has the advantage of leaving four bits for use as determined by the application, by defining a four bit short_priority_id field, which the encoder would be free to use to provide a coarse indication of 1-D priority.

When extension_flag is equal to 1, short_priority_id is not used by the decoding process specified in JSVM3. The syntax element short_priority_id may be used as determined by the application.

Since fragment_order information is specified in a NAL unit header or a SPS, we can remove it from the slice header, as shown in TABLE 3.

For the same reason, in Scalability Information SEI message, we can add fragment_order as indicated in Table 6. fragment_order[i] is equal to fragment_order of the NAL units in the scalable layer with the layer identifier equal to i.

TABLE 6

| scalability_info( payloadSize ) { | C | Descriptor |
|---|---|---|
| num_layers_minus1 | 5 | ue (v) |
| for ( i = 0; i <= num_layers_minus1; i++ ) { | | |
| .... | | |
| if (decoding_dependency_info_present_flag[ i ]) | | |
| { | | |
| temporal_level[ i ] | 5 | u (3) |
| dependency_id[ i ] | 5 | u (3) |
| quality_level[ i ] | 5 | u (2) |
| fragment_order[ i ] | 5 | u (2) |
| } | | |
| .... | | |
| } | | |
| } | | |

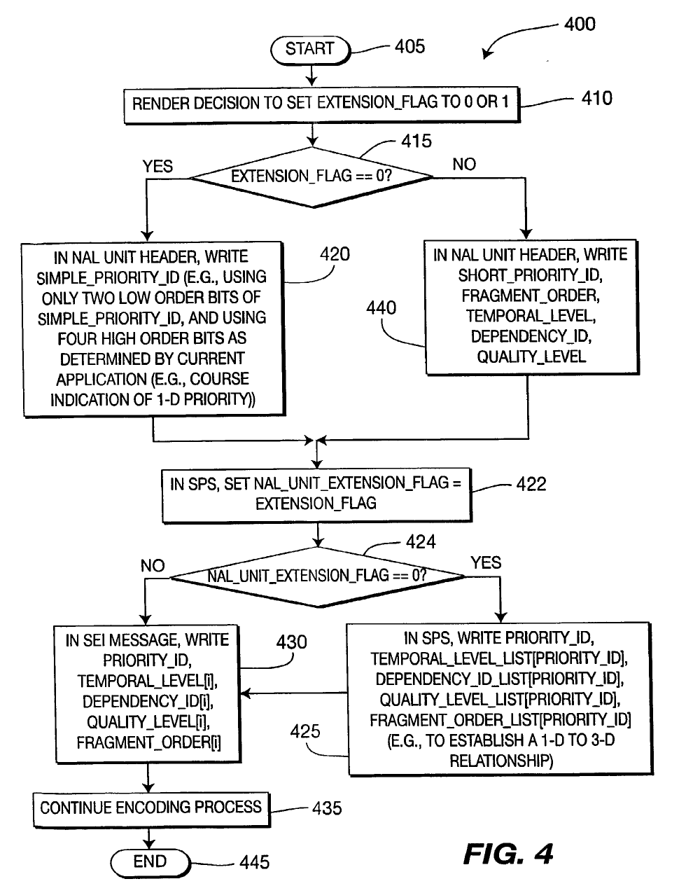

Turning to FIG. 4, an exemplary method for scalable video encoding using high-level syntax is indicated generally by the reference numeral 400. The method 400 includes a start block 405 that passes control to a function block 410. The function block 410 renders a decision to set extension_flag to 0 or 1, and passes control to a decision block 415. The decision block 415 determines whether or not extension_flag is equal to 0. If so, then control is passed to a function block 420. Otherwise, control is passes to a function block 440.

The function block 420 writes simple_priority_id in a network abstraction layer (NAL) unit header, and passes control to a function block 422. simple_priority_id may be written in the NAL unit header using only the two low order bits, with the four high order bits being used as determined by the current application (e.g., for providing a coarse indication of 1-D priority).

The function block 440 writes, in a NAL unit header, short priority_id, fragment_order, temporal_level, dependency_id, quality_level, and passes control to the function block 422.

The function block 422 sets nal_unit_extension_flag equal to extension_flag in a sequence parameter set (SPS), and passes control to a decision block 424. The decision block 424 determines whether or not nal_unit_extension_flag is equal to 0. If so, then control is passed to a function block 425. Otherwise, control is passed to a function block 430.

The function block 425 writes, in the sequence parameter set (SPS), priority_id, temporal_level_list[priority_id], dependency_id_list[priority_id], quality_level_list[priority_id], fragment_order_list[priority_id], and passes control to a function block 430. fragment_order_list[priority_id] may be used to establish a 1-D to 3-D relationship.

The function block 430 writes, in a supplemental enhancement information (SEI) message, priority_id, temporal_level[i], dependency_id[i], quality_level[i], fragment_order[i], and passes control to a function block 435. The function block 435 continues the encoding process and, upon completion of the encoding process, passes control to a function block 445.

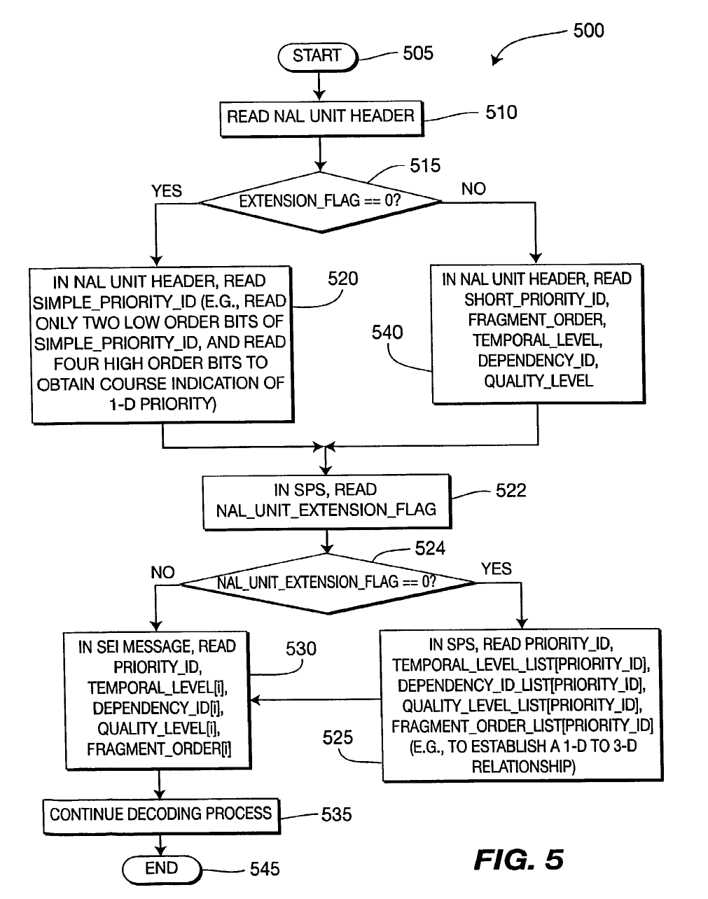

Turning to FIG. 5, an exemplary method for scalable video decoding using high-level syntax is indicated generally by the reference numeral 500. The method 500 includes a start block 505 that passes control to a function block 510. The function block 510 reads a NAL unit header, and passes control to a decision block 515. The decision block 515 determines whether or not extension_flag is equal to 0. If so, then control is passed to a function block 520. Otherwise, control is passes to a function block 540.

The function block 520 reads simple_priority_id in a network abstraction layer (NAL) unit header, and passes control to a function block 522. simple_priority_id may be read in the NAL unit header using only the two low order bits, with the four high order bits being read for a use as determined by the current application (e.g., for providing a coarse indication of 1-D priority).

The function block 540 reads, in a NAL unit header, short_priority_id, fragment_order, temporal_level, dependency_id, quality_level, and passes control to the function block 522.

The function block 522 reads nal_unit_extension_flag in a sequence parameter set (SPS), and passes control to a decision block 524. The decision block 524 determines whether or not nal_unit_extension_flag is equal to 0. If so, then control is passed to a function block 525. Otherwise, control is passed to a function block 530.

The function block 525 writes, in the sequence parameter set (SPS), priority_id, temporal_level_list[priority_id], dependency_id_list[priority_id], quality_level_list[priority_id], fragment_order_list[priority_id], and passes control to a function block 530. fragment_order_list[priority_id] may be used to establish a 1-D to 3-D relationship.

The function block 530 reads, in a supplemental enhancement information (SEI) message, priority_id, temporal_level[i], dependency_id[i], quality_level[i], fragment_order[i], and passes control to a function block 535. The function block 535 continues the decoding process and, upon completion of the decoding process, passes control to a function block 545.

A description will now be given of some of the many attendant advantages/features of the present invention, some of which have been mentioned above. For example, one advantage/feature is a scalable video encoder that includes an encoder for encoding video signal data by adding fragment order information in a network abstraction layer unit header. Moreover, another advantage/feature is the scalable video encoder as described above, wherein the encoder adds the fragment order information to a network abstraction layer unit header when an extension_flag field corresponding to the network abstraction layer unit header is equal to 1 or in a sequence parameter set when a nal_unit_extension_flag field corresponding to the sequence parameter set is equal to 0. Further, another advantage/feature is the scalable video encoder that adds the fragment order information to the network abstraction layer unit header as described above, wherein the fragment order information includes a fragment_order syntax, and the encoder adds the fragment_order syntax in the sequence parameter set when the nal_unit_extension_flag field is equal to 0 to establish a 1-D to 3-D scalability relationship. Also, another advantage/feature is the scalable video encoder that adds the fragment order information including the fragment_order syntax as described above, wherein the encoder only uses two low order bits in a simple_priority_id field for the fragment_order syntax when the extension_flag field is equal to 1. Additionally, another advantage/feature is the scalable video encoder that adds the fragment order information including the fragment_order syntax as described above, wherein the encoder provides four high order bits of a simple_priority_id field for use as determined by a current application, such use being independent of the fragment information. Moreover, another advantage/feature is the scalable video encoder that adds the fragment order information including the fragment_order syntax and that provides four high order bits of a simple_priority_id field as described above, wherein the encoder uses the four high order bits of the simple_priority_id field to provide a coarse indication for 1-D priority. Further, another advantage feature is a scalable video encoder that includes an encoder for encoding video signal data by adding fragment order information in a scalable supplementary enhancement information message.

These and other features and advantages of the present invention may be readily ascertained by one of ordinary skill in the pertinent art based on the teachings herein. It is to be understood that the teachings of the present invention may be implemented in various forms of hardware, software, firmware, special purpose processors, or combinations thereof.

Most preferably, the teachings of the present invention are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

1. An apparatus comprising:
an encoder for encoding scalable video signal data by adding fragment order information in a network abstraction layer unit header.

2. The apparatus of claim 1, wherein said encoder adds the fragment order information to a network abstraction layer unit header when an extension_flag field corresponding to the network abstraction layer unit header is equal to 1 or in a sequence parameter set when a nal_unit_extension_flag field corresponding to the sequence parameter set is equal to 0.

3. The apparatus of claim 2, wherein the fragment order information includes a fragment_order syntax, and said encoder adds the fragment_order syntax in the sequence parameter set when the nal_unit_extension_flag field is equal to 0 to establish a one-dimensional to three-dimensional scalability relationship.

4. The apparatus of claim 3, wherein said encoder only uses two low order bits in a simple_priority_id field for the fragment_order syntax when the extension_flag field is equal to 1.

5. The apparatus of claim 3, wherein said encoder provides four high order bits of a simple_priority_id field for use as determined by a current application, such use being independent of the fragment information.

6. The apparatus of claim 5, wherein said encoder uses the four high order bits of the simple_priority_id field to provide a coarse indication for one-dimensional priority.

7. An apparatus comprising:
an encoder for encoding video signal data by adding fragment order information in a scalable supplementary enhancement information message.

8. A method for scalable video encoding, comprising:
encoding video signal data by adding fragment order information in a network abstraction layer unit header.

9. The method of claim 8, wherein said adding step adds the fragment order information to a network abstraction layer unit header when an extension_flag field corresponding to the network abstraction unit header is equal to 1 or in a sequence parameter set when a nal_unit_extension_flag field corresponding to the sequence parameter set is equal to 0.

10. The method of claim 9, wherein the fragment order information includes a fragment_order syntax, and said adding step adds the fragment_order syntax in the sequence parameter set when the nal_unit_extension_flag field is equal to 0 to establish a one-dimensional to three-dimensional scalability relationship.

11. The method of claim 10, wherein said adding step only uses two low order bits in a simple_priority_id field for the fragment_order syntax when the extension_flag field is equal to 1.

12. The method of claim 10, further comprising providing four high order bits of a simple_priority_id field for use as determined by a current application, such use being independent of the fragment information.

13. The method of claim 12, wherein said adding step uses the four high order bits of the simple_priority_id field to provide a coarse indication for one-dimensional priority.

14. A method for scalable video encoding, comprising:
encoding video signal data by adding fragment order information in a scalable supplementary enhancement information message corresponding to the video signal data.

15. An apparatus comprising:
a decoder for decoding scalable video signal data by reading fragment order information in a network abstraction layer unit header corresponding to the scalable video signal data.

16. The apparatus of claim 15, wherein said decoder reads the fragment order information in a network abstraction layer unit header when an extension_flag field corresponding to the network abstraction unit header is equal to 1 or in a sequence parameter set when a nal_unit_extension_flag field corresponding to the sequence parameter set is equal to 0.

17. The apparatus of claim 16, wherein the fragment order information includes a fragment_order syntax, said decoder reads the fragment_order syntax in the sequence parameter set when the nal_unit_extension_flag field is equal to 0 to establish a one-dimensional to three-dimensional scalability relationship.

18. The apparatus of claim 17, wherein said decoder reads only two low order bits in a simple_priority_id field for the fragment_order syntax when the extension_flag field is equal to 1.

19. The apparatus of claim 17, wherein said decoder reads four high order bits of a simple_priority_id field to obtain a coarse indication for one-dimensional priority.

20. An apparatus comprising:
a decoder for decoding video signal data by reading fragment order information in a scalable supplementary enhancement information message corresponding to the video signal data.

21. A method for scalable video decoding, comprising:
decoding video signal data by reading fragment order information in a network abstraction layer unit header corresponding to the video signal data.

22. The method of claim 21, wherein said reading step reads the fragment order information in a network abstraction layer unit header when an extension_flag field corresponding to the network abstraction unit header is equal to 1 or in a sequence parameter set when a nal_unit_extension_flag field corresponding to the sequence parameter set is equal to 0.

23. The method of claim 22, wherein the fragment order information includes a fragment_order syntax, and said reading step reads the fragment_order syntax in the sequence parameter set when the nal_unit_extension_flag field is equal to 0 to establish a one-dimensional to three-dimensional scalability relationship.

24. The method of claim 23, wherein said reading step reads only two low order bits in a simple_priority_id field for the fragment_order syntax when the extension_flag field is equal to 1.

25. The method of claim 23, wherein said reading step reads four high order bits of a simple_priority_id field to obtain a coarse indication for one-dimensional priority.

26. A method for scalable video decoding, comprising:
decoding video signal data by reading fragment order information in a scalable supplementary enhancement information message corresponding to the video signal data.

27. A video signal structure for encoded video, comprising:
video signal data having fragment order information in a network abstraction layer unit header.

28. A storage media having video signal data encoded thereupon, comprising:
video signal data having fragment order information in a network abstraction layer unit header.

29. A video signal structure for encoded video, comprising:
video signal data having fragment order information in a scalable supplementary enhancement information message.

30. A storage media having video signal data encoded thereupon, comprising:
video signal data having fragment order information in a scalable supplementary enhancement information message.
